(19) United States
(12) Patent Application Publication
(10) Pub. No.: US 2014/0279271 A1
(43) Pub. Date: Sep. 18, 2014

(54) Systems and Methods for Configuring a Group Order and Automatic Generation of Group Order Notification and Feedback Conforming to Pre-Specified Feedback Constraints

(71) Applicant: VISTAPRINT TECHNOLOGIES LIMITED, Hamilton (BM)

(72) Inventors: David A. Goldman, Bedford, MA (US); Eugene Hsu, Somerville, MA (US); Susan C. Rice, Northborough, MA (US); David A. Yuknat, Dover, MA (US)

(73) Assignee: Vistaprint Technologies Limited, Hamilton (BM)

(21) Appl. No.: 13/835,503

(22) Filed: Mar. 15, 2013

(51) Int. Cl. G06Q 30/06

(52) U.S. Cl. CPC G06Q 30/0635
USPC 705/26.81

(57) ABSTRACT

Systems, methods and tools facilitate efficient and convenient e-commerce based group ordering. A group order organizer tool allows a group order organizer to create and configure a group order, specify group members, specify and configure information to be solicited from group members, and customize various details of the group order. The group order tool automatically generates member-specific group order notification documents containing member-specific input controls to allow individual group members to input solicited information. Group order notification and management tools send out the group order notification documents to the group members and manage the responses.

### BACKGROUND OF THE INVENTION

The present invention relates generally to electronic commerce, and more particularly to systems, methods and tools for generating and managing group orders of products, including tools for configuring and customizing constraints for the types and features of items that can be ordered in a group order, and notification and tracking tools for notifying group members of the group order and tracking group order responses.

Often, a group of people desires to each order a particular similar item for each of the members of the group. The group may be a sports team, a social club, a family, a group of friends, a political, religious or social organization, or any other group of people that are linked together via some common cause or social link. The item that is desired to be ordered may be a product or service that each member of the group is supposed, or allowed, to order. For example, a group may desire to issue a similar t-shirt with a particular emblem on it to each member of the group to identify each group member as being part of the group when the individual group member wears the t-shirt. As another example, a group may desire to gift a service to each individual in the group and have the individual services processed as a group order. The item that is to be ordered may have associated therewith various options that different people in the group should be allowed to choose. For example, a t-shirt that is to be ordered for each person in the group may come in various sizes and each person in the group may be allowed or required to select their desired size. Depending on the breadth of feature choices for an item, it may be desired to place constraints on the selectable features of the item that the group members can order. In the t-shirt example, the organizer of the group order may specify a particular style, color and logo to be placed on each t-shirt, and constrain the number of t-shirts that each member can order to a single t-shirt. In the service example, the group organizer may wish to allow each member of the group to select one and only one service from a pre-selected set of different services, and to specify an appointment time from a set of available appointment times.

In the past, group order organizers would typically have to order a particular product or service and hope to pick a selection of products (including an array of possible sizes or other such options) or services (including other options such as appointment reservation times) and hope that the members of the group would be able to find a product or service from those ordered to suit their needs. For example, in the recent past a manager of a sports team having 15 team members may order 10 large t-shirts, 5 medium t-shirts, and 5 small t-shirts. Members of the group would then choose a t-shirt of a particular size, with the risk that some team members end up with a t-shirt of the wrong/undesired size. In addition, this approach requires the group order organizer to over-purchase t-shirts in each size to increase the likeliness that all team members end up with an appropriately-sized t-shirt. Such an approach adds cost in terms of cost for the unwanted extra shirts, and waste. The team manager or group order organizer could try to manage this by polling the members for desired size prior to placing the order, but this requires keeping track of who ordered which shirt, as well as additional work on the group order organizer's part in collecting shipment and payment information.

It would be desirable to have tools and techniques available to allow a person to design a group order with the ability to place constraints on the particular items and features of the items to be ordered, place constraints on parameters of the order itself, manage payment and shipping options, and manage notification to and solicitation of information unique to each group member, and tracking of responses from individual members of the group.

### SUMMARY OF THE INVENTION

Systems, methods and tools facilitate efficient and convenient e-commerce based group ordering. A group order organizer tool allows a group order organizer to create and configure a group order, specify group members, specify and configure information to be solicited from group members, and customize various details of the group order. The group order tool automatically generates member-specific group order notification documents containing member-specific input controls to allow individual group members to input solicited information. Group order notification and management tools send out the group order notification documents to the group members and manage the responses.

In an embodiment, a method for facilitating group orders includes providing a user interface which allows a user to select one or more items to be included in a group order, to configure one or more features of the group order, to configure one or more of the features of the group order to be configurable by individual group members, to provide contact information associated with one or more group members to be included in the group order, and to generate a group order notification document associated with the group order, the group order notification document containing one or more controls to allow a group member recipient of the group order notification document to indicate a desired configuration for the group member configurable features specific to the group member recipient. The method further includes receiving from selections of one or more items to be included in a group order, receiving configurations of one or more features of the group order, receiving configurations of one or more features of the group order to be configurable by individual group members, and receiving contact information associated with one or more group members to be included in the group order. The method further includes generating at least one group order notification document associated with the group order, each group order notification document containing one or more controls to allow a group member to indicate a desired group member configurable features configuration specific to that group member. The method further includes associating at least one of the at least one group order notification documents with each group member from which configurable feature selections are solicited. The method further includes notifying each group member from which configurable feature selections are solicited of the group order and providing access to the group order notification document associated with the notified group member. The method further includes receiving, via the one or more controls in at least one of the at least one group order notification documents, one or more desired configurations specific to a notified group member. The method further includes updating the group order configurations with the received configurations specific to the notified group member.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a process flow diagram for an exemplary group ordering process;

FIG. 2 is a schematic block diagram illustrating an embodiment of a system in which various aspects of the invention may operate;

FIG. 3A is a schematic diagram illustrating an example user interface that may be displayed on the screen of the group order organizer's client computer or mobile device display;

FIG. 3B is a schematic diagram illustrating an example of a second user interface that may be presented to a group order organizer in the group order process flow;

FIG. 3C is a schematic diagram illustrating an example of a third user interface that may be presented to a group order organizer in the group order process flow;

FIG. 3D is a schematic diagram illustrating an example of a fourth user interface that may be presented to a group order organizer in the group order process flow;

FIG. 3E is a schematic diagram illustrating an example of a fifth user interface that may be presented to a group order organizer in the group order process flow;

FIG. 3F is a schematic diagram illustrating an example of a sixth user interface that may be presented to a group order organizer in the group order process flow;

FIG. 3G is a schematic diagram illustrating an example of a seventh user interface that may be presented to a group order organizer in the group order process flow;

FIG. 4A is an example of a member-specific group order notification document in the form of an email message;

FIG. 4B is an example of an email notification containing a link to a member-specific group order notification document;

FIG. 4C is an example of a web page displayed in a member's browser which contains a member-specific group order notification document;

FIG. 5 is a flowchart of an exemplary method for facilitating a group order;

FIG. 6 is a schematic block diagram of an exemplary embodiment of a group order tool; and

FIG. 7 is a schematic block diagram of an exemplary computing device which may be used in implementing any of the computer systems, servers, mobile devices, networked devices, and/or components of such systems.

### DETAILED DESCRIPTION

Described herein are methods, systems and tools for creating and managing a collaborative group order. In general, a group order is created by a group order organizer and configured with some locked features and some configurable features that are to be selected by individual group members, group member contact information and other notification parameters are input, group members are notified and individual information specific to each group member is solicited, and group order responses received from group members are received and managed.

FIG. 1 illustrates an embodiment of an exemplary process flow for implementing a collaborative group order. As illustrated, in step 101 a group order organizer selects an item which will be offered to members of the group for order. Selection of the item to be offered may involve some preliminary customization of features of the item that individual group members will not be able to change. For example, a design to be printed or otherwise affixed to the item may be specified. In step 102, the group order organizer initiates a group order, which activates a user interface which provides controls for allowing the group order organizer in step 103 to select and constrain one or more features of the item to be offered for group order. In particular, in step 103 the group order organizer may designate certain features of the item or order as being selectable and customizable by the individual group members. As will be described in more detail hereinafter, one or more features of the item to be offered in the group order may be locked, via the group order design tool functionality, to prevent editing by the group members to which the group order is to be sent. Similarly, as further described hereinafter, one or more features of the item to be offered in the group order may be set to be unlocked, via the group order design tool functionality, to allow selection and configuration (in some cases “constrained” configuration) by the individual group members to which the group order is to be sent. The group order organizer may further constrain, via the group order design tool functionality, the possible selections and configurations of various ones of the unlocked features to constrain the allowable selections and configurations to a smaller subset of all possible selections and configurations. The group order organizer can add additional items to the group order and customize and constrain feature selection by group members.

When the group order organizer is satisfied with the selected items to be offered in the group order, and their associated feature configurations, and associated 3^{rd} party selection constraints, the group order organizer may then move to step 104 in order to select various notification options. In an embodiment, this entails defining a list of the individual members of the group, including at least some identifying contact information. In a preferred embodiment, the contact information is an email address or a text messaging (SMS or MMS) address (i.e., a mobile device phone number). The Notification options may include additional options, including but not limited to options for handling response tracking, as discussed in more detail hereinafter.

In step 105, the group order organizer configures various group order details, including but not limited to payment options (e.g., are individual members to each pay for themselves via an online payment process, or will the group order organizer submit or authorize a payment for the entire order and perhaps collect from the individual group members outside the system?) and shipping options (e.g., will the entire order be shipped to a single address, or will the items specific to each individual group member be shipped directly to that individual?). Once the group order details are defined, a set of group member order notification documents configured and created specific to each individual group member are automatically generated and each group order notification document is sent to each corresponding individual group member in the notification list. In an embodiment, the group order notification document is sent via one or more of the selected channel (e.g., email, SMS, MMS, Facebook post, Instagram notification, Google Circle Notification, or other social media notification channel, etc.) to each of the members of the group designated in the notification list.

A group order design tool, discussed in connection with FIG. 2, provides a user interface for allowing the group order organizer to create and configure the group order, and further provides the functionality for automatically generating the group member order notification documents, sending out the notifications, and tracking responses, and providing a user interface for allowing the group order organizer to manage and track the group order and individual member responses. In a preferred embodiment, the group member order notification document specific to each group member is included in the notification sent to that individual group member. In other words, the group order design tool provides the capability for a group order organizer (i.e., a person) to automatically create a simplified order document for distribution to each member of a group that notifies the individual member of the group of the creation of the group order, that certain member-specified selections pertaining to items in the order are solicited from the individual member, and instructions for responding with individual group member-specific selections/customizations.

Upon receipt by a group member of the group member order notification, the group member reviews the group member order notification document in step 111, performs any actions per the instructions indicated in the notification, makes one or more member-selectable selections and/or provides any requested input, and responds in step 112 using the method called for in the instructions. In an embodiment, the group member order notification document is an email or text message and contains one or more controls (such as but not limited to a hyperlink, a checkbox, a radio button, a text field, etc.) associated with a group member-configurable feature. In an embodiment, the selection by an individual group member of a control in the group order notification document may trigger the submission of the selection information by the individual group order member. Alternatively, submission of one or more selections may be triggered later by a secondary action such as may be outlined per the instructions in the notification. Examples of such secondary action may include e-mail response, SMS text, hyperlink click, or web form submission.

The group order organizer is preferably made aware of the various individual responses and provided with tools to manage the responses in step 106, finalize the group order, and request fulfillment of the order.

Referring now to FIG. 2, there is shown therein an embodiment of a system in which various aspects of the invention may operate. One or more order processing server system(s) 210 are equipped with typical processing functionality, including one or more processors 211, program memory 214 containing program instructions for various applications and tasks, data memory 212 for storing data used by applications and in the performance of the various tasks, and communication hardware and software (not shown) configured to enable data communication with remote devices, for example via a network 240 such as the Internet. An order processing server 210 may itself, or in conjunction with additional servers such as webhosting servers (not shown), serve pages 213 of an online retailer website in order to offer items such as products and services available for ordering. The pages served by the server 210 are preferably implemented in a browser-renderable format such as HyperText Markup Language, or some variant thereof which is well-known in the art. The pages 213 preferably include one or more controls for invoking a group order management tool 216 to allow a visitor to the website to create and manage a group order of products or services. The order processing server(s) may further include one or more design tool(s) 214 which a visitor to the website may invoke to specify design customizations to products or services available for ordering at the website.

In general, visitors to the website are people operating client machines executing a web browser by entering the Universal Resource Locator (URL) (i.e., website address) or by otherwise navigating to the website. The visitors to the website may desire to order one or more products or services. Occasionally, a visitor to a website may desire to order multiple products or services to be distributed to multiple different individuals or members of a group. For example, a group order organizer (i.e., a person) may be operating a client machine 250 (configured with one or more processors 251, program memory 252 and data memory 255) which executes a browser program 253 from which the group order organizer navigates to the retail website. A page 213 of the website is served to the group order organizer's client machine and displayed to the group order organizer. From the page, the group order organizer may navigate to other pages of the website to select one or more products for ordering, design the one or more product, and set up a group order. Upon selection of a product, for example, a page of the website may contain a control which when activated by the group order organizer invokes a design tool 254 allows the user to customize design features of a selected product. One or more pages 216 further includes one or more controls which when activated by the group order organizer invokes a group order tool 253 which allows the group order organizer to create a group order, configure and customize various options including, for example by way of illustration and not limitation, item selection options, shipping options and payment items. The group order tool 253 further allows the group order organizer to specify contact information for members of the group, notification options which set how the group members are notified, and further provides a group order management functionality which allows the group order organizer to monitor and track responses to group order notifications.

In an embodiment, one or the other, or both, of the design tool(s) 254 and group order tool(s) may be downloaded from the server 210 to execute within the browser 253 of the client machine 253. In an alternative embodiment, one or the other, or both, of the tools 253, 254 execute at the server 210.

Upon submission of a group order by a group order organizer, the group order tool 216 automatically generates a set of group member specific group order notification documents. In an embodiment, the group order tool 216 automatically sends out the set of group member specific group order notification documents to the specific group members. In a preferred embodiment, the group order tool 216 collects an address such as an email address, a SMS number, etc., and sends the notification documents via an electronic method of communication (i.e., via email, SMS, etc.).

Group members operate client machines 260, 270, which are equipped with one or more processor(s) 261, 271, program memory 262, 272, and data memory 264, 274, and data communication hardware/software (not shown). The group member client machines 260, 270 are communicatively connected to the network 240 such as the Internet. Client machine 260 includes at least an email application 263 configured to receive and transmit email messages. Client machine 270 includes at least an SMS application 273 configured to receive and transmit SMS messages.

The group order tool 216 sends each member specific group order notification document via the channel specified in the order. For example, if a group member's email address is set as the communication channel, the group order tool 216 sends the member-specific group order notification document via email. When the group order notification document is received at the group member's email client, the group order notification document appears in the group member's email inbox. If instead a group member's SMS number is set as the communication channel, the group order tool 215 sends the member-specific group order notification document via SMS. When the group order notification document is received at the group member's SMS client, the group order notification document appears in the group member's SMS queue.

As will be made apparent shortly hereinafter, the group order notification document contains a notification that a group order is in process, solicits one or more member-specific information or selection(s), and instructions for how to respond to the notification. In a preferred embodiment, the notification includes one or more controls which when activated by the group member recipient, triggers the indication of a selection or other solicited information.

In a preferred embodiment, the group order tool 216 is a program or application that executes on a server 210 and manages the collection and receipt of feature selections by individual group members. In an embodiment, the group order organizer can access the server 210 and use the group order tool 216 to view the order, view the status of the individual member responses, view and/or edit the order (such as the order close date, the payment options, shipping options, notification options, notification list, etc.), and send messages to the group. In an embodiment, the group order organizer has the option to receive a notification each time a group member submits an order response, or alternatively to receive a notification when all responses have been received, or alternatively to not receive a notification. In an embodiment, the group order organizer may configure the group order to automatically checkout on a particular date/time (i.e., charge the invoice amount to a credit card on file and submit the order to the fulfillment provider for fulfillment), or alternatively to require user input from the group order organizer (or other designated party) to perform one or more of the payment and order submission actions.

Turning now to a use case example, FIGS. 3A-3H show a set of user interface pages that may be displayed to a group order organizer in the course of using a group order tool 216. The group order tool 216 may be invoked from various applications and interfaces. In the present example, it is assumed that a group order organizer has accessed a t-shirt design and fulfillment website, completed the design process for a particular t-shirt, and now desires to create a group order and has invoked the group order tool 216.

FIG. 3A shows an example user interface 310 that may be displayed on the screen of the group order organizer's client computer or mobile device display. As shown, the user interface 310 includes a preview image 311 of the front side of a selected t-shirt (i.e., the item to be offered in the group order). The preview image 311 shows the group order item with all customized features as selected by the group order organizer. In the present example, the group order organizer has selected a t-shirt, along with a logo image 312, placement of the logo image, and text 313 to be printed above the logo image. These features (i.e., the logo feature, the text feature, the placement features, etc.) are design features that are to be printed, embroidered, adhered, or otherwise affixed to the t-shirt. Other customizable features are directed to the t-shirt itself, including t-shirt color, type, and size.

In general, the user interface includes at least one control for each customizable option of the item to be ordered. In the example user interface 310 shown in FIG. 3A, each customizable option appears as a configurable field. For example, the user interface 310 includes a text field 313a which receives user text input 313b. The text field 313a corresponds to the text 313 located above the logo image 312 on the t-shirt and text entered in the text field 313a by a user (e.g., the group order organizer) is what appears in the preview image 311, and will be included on the final shipped t-shirt item. In the example, the user interface 310 also includes an image field 312a in which the user can enter as input 312b the name and path (i.e., location) of an image file to be used as the corresponding image 312 on the t-shirt. In the present example, there are also fields 314a, 315a, 316a corresponding to product options such as t-shirt color 314, t-shirt style 315, and t-shirt size 316.

Each of the fields 312a, 313a, 314a, 315a, 316a is configurable by the group order organizer and can be set to a locked state or an unlocked state. In the locked state, the configuration or contents of a field cannot be modified by end users (i.e., the individual group members associated with the group order). In the present example, the text field 313a and image field 312a are both set to the locked state to prevent the individual group members from ordering a t-shirt with different text or a different logo. In the unlocked state, the configuration or contents of a field may be modified, set, or otherwise selected by the end user. In the present example, the t-shirt color, style, and size are set to the unlocked state to allow the end user to select a desired color, style and size. Each field 312a, 313a, 314a, 315a, 316a has displayed therewith an associated icon 312a, 313a, 314a, 315a, 316a or status indicator which shows the current state of the associated field as being either locked (where the icon is displayed as a closed padlock) or unlocked (where the icon is displayed as an open padlock). The state of the field can be toggled by clicking on the status indicator icon 312a, 313a, 314a, 315a, 316a associated with the field to activate an associated status active control to toggle the state of the field.

Some fields can be configured further to constain end users to selection from a limited specified set of options associated with the field from a larger set of options that may be available in general for the item. In FIG. 3A, when an item feature includes options that can be further constrained, an edit icon appears next to the associated field. For example, in FIG. 3A, an edit icon 315d, 316d appears next to fields 315a, 316a. When the group order organizer clicks on one of the edit icons, an active control associated with the icon activates a user interface 320 for constraining the available options from the full set of available options to a limited or “constrained” set of options. For example, FIG. 3B shows a pop-up window that appears on the group order organizer's display when the group order organizer clicks on the edit icon 316d associated with the color field 316a. As illustrated, a list of available colors for the item is displayed, along with a checkbox control 321b-329b next to (and associated with) each individual color description 321a-329a. (Other types of active controls can be substitutes, for example, radio buttons, hyperlinks, etc.). The group order organizer can click the checkboxes appearing next to the colors from which the group members will be allowed to select, and then the group order organizer can click the save button 320a to save the constraints associated with the color option. When the group notification is sent out, group members will only be allowed to select from the constrained set of colors. Of course, it will be appreciated that the user interface for constraining a set of available options for a particular feature to a limited set of options selectable by the individual group members may vary from implementation to implementation.

FIG. 3C shows an example user interface 330 that may be displayed on the screen of the group order organizer's computer or mobile device display after the group order organizer has configured the front side of the t-shirt and clicked the “Next” button (control or hyperlink) on the user interface of FIG. 3A. As shown, the user interface 330 includes a preview image 331 of the back side of the selected t-shirt. The preview image 331 shows the back side of the selected t-shirt with all customized features as selected by the group order organizer. Similar to the user interface shown in FIG. 3A for configuring the front side of the t-shirt, the user interface 330 in FIG. 3C for configuring the back side of the t-shirt includes at least one control for each customizable option of the item to be ordered. In the example user interface 330 shown in FIG. 3C, each customizable option appears as a configurable field. For example, the user interface includes a name field 332a in the form of a text box which receives user text input 332b. The name field 332a includes the sample text “Your Name Here” 332b to indicate to the end user that the user's name is to be inserted in the text box associated with the name field 332a. A player number field 333a includes a sample number “00” 333b to indicate to the end user that the user's player number (e.g., player number on a team) is to be entered into the text box associated with the player number field 333b. The preview image 331 is updated to show the respective features (name 332, player number 333) corresponding to the contents of the text boxes in the associated fields.

Again, each of the fields 332a, 332b is configurable by the group order organizer and can be set to a locked state or an unlocked state. In the present example, the name field 332a is set to the unlocked state to allow the end user to enter their name to be printed or otherwise affixed to the back side of the t-shirt. Further in the present example, the player number field 333a is shown as set to the locked state which would prevent the end user from modifying the contents of the text box associated with the player number field (thereby preventing the end user from modifying the player number to be printed or otherwise affixed to the back side of the t-shirt). Each field has displayed therewith an associated status indicator icon 332c, 333c (which has associated therewith an active control to toggle the state). The icons 332c, 333c indicate the current state of the associated field 332a, 333a as being either locked (displayed as a closed padlock) or unlocked (displayed as an open padlock). The status indicator icon can be clicked on to toggle the state of the field. For example, it may be desirable to allow each group member to order a t-shirt with their unique player number printed on the back side of the t-shirt. In this case, the group order organizer would click on the status indicator icon 333c associated with the player number field 333a in the user interface 330 to toggle the status from the unlocked state as shown in FIG. 3B to an unlocked state (not shown). In the unlocked state, the group member would then be able to change the player number to be printed or otherwise affixed to the shirt.

FIG. 3D shows an example user interface 340 that may be displayed on the screen of the group order organizer's computer or mobile device display after the group order organizer has completed the configuration of both the front and back sides of the t-shirt and clicked the “Next” button (control or hyperlink) on the user interface of FIG. 3B. As shown, the user interface 340 includes an interface for adding group participants (or group “members”) to be included in the group order. In this user interface 340, an input text box 341 is provided in which the group order organizer can manually enter the email address or SMS # of the individual group members.

In a preferred embodiment, the contact input box 341 is an intelligent control which operates to recognize the difference between an email address and an SMS number. In an embodiment, the contents of the contact input box 341 are parsed by an application or script executing on the local device (i.e., the group order organizer's client machine 250), or on the backend server 210. In an embodiment, the email addresses and SMS numbers are parsed in realtime, compared with contact information stored in the local device or on an accessible server, and replaced (where associated contact information is found) with the group member's name. Thus, john@company.com may be dynamically replaced with a name associated with the email address in the group order organizer's contact database(s) to become, for example, John Doe (where John Doe appears in the contact database associated with the email address john@company.com). Similarly, the number 6715555555 may be dynamically replaced with a name from the contacts database that is associated with the SMS number (for example, Sherry Parker). Alternatively, these names displayed in place of the email addresses and SMS numbers only after the group order organizer clicks the Next button.

The user interface 340 may also offer additional options for entering group member contact information. For example, the user interface 340 may include a control to allow a group order organizer to upload or import a list of addresses. In the user interface 340, this functionality is provided by way of a hyperlink 343 which is displayed as “Upload a List”. Functionality for importing and uploading contact lists is well-known in the art, many of which may be implemented to perform the list importation/upload functionality associated with the hyperlink 343.

The user interface 340 may further allow specification of advanced options. For example, a button 344 labeled “Advanced Options” may be clicked to display the user interface 350 shown in FIG. 3E. The Advanced Options user interface 350 allows the group order organizer to configure features or feature settings for individual members if desired. In an embodiment, the Advanced Options further allow the group order organizer to notify only a subset of the individual group members. For example, if the group order organizer knows the desired selections for certain members of the groups but is unsure about the desired selections for other members, the group order organizer can send out notifications only to those members for which the desired settings are unknown.

For example, the advanced options user interface includes an input text box associated with a name field into which a given group participant's name is to be inserted, an input text box associated with an email address field into which the given group participant's email address is to be inserted, and an input text box associated with an SMS number field into which the given group participant's SMS number is to be inserted. These input text boxes may be auto-populated, by the group order tool and using known technology, with corresponding contact data from the group order organizer's contact database or another database based on the email addresses and/or SMS numbers entered in the contact input box 341. The group order organizer may also manually enter the information for individual group members by entering the corresponding information into the respective participant fields. The user interface may include additional input fields for adding additional group members, and may further include a control to create additional record fields on the user interface for additional group members. That is, in the present example shown in FIG. 3E, when a user clicks on the control “+”, a new record containing a blank set of name, email address, and SMS input boxes is created and displayed on the user interface to allow the user to add the information for another group member.

In an embodiment, the user interface 350 also includes controls to allow the group order organizer to set the selections for the various configurable item features and to insert payment and shipping information on a group member by group member basis, if desired. This allows the group order organizer to fill in information for certain group members who are unavailable or unable to respond to the group order notification but whose selections should be included in the final order. For example, in the user interface shown in FIG. 3E, each group member record includes a control for each configurable item option (e.g., size, color, style, in the form of drop-down lists) to allow the group order organizer to select one of the possible options on a feature by feature basis. The user interface 350 also includes selection controls for setting the selections for the various notification options, payment options, and shipping options. Again, the group order organizer can set the configurations for some group members and leave the configurations of other group members unselected—that is, each item feature and notification, payment, and shipping option is individually configurable on a group member by group member basis, thereby allowing different member-specific notifications containing input solicitation for those features and options that which remain to be selected or which require input from the respective individual member. For example, a sports team may desire each member to select a t-shirt size, and for each member except for two scholarship recipients to pay for their own t-shirt while the team will pay for the t-shirts for the two scholarship recipients. In this scenario, the group order organizer could set the payment option for the two scholarship recipients to “I'll pay” and for all other members of the group to “They'll pay”. The group order tool includes the intelligence to configure the content of the group order notification document to solicit t-shirt size and payment information from all group member recipients except for the two scholarship recipients (who are not to make a payment). The group order tool configures the content of the group order notification document sent to the scholarship recipients to solicit the t-shirt size but not payment information.

After clicking on the Next button in either of FIG. 3D or 3E, an order options user interface 360 shown in FIG. 3F is displayed to the group order organizer. The order options user interface 360 includes a message input text box 361 where the group order organizer can insert a message to be included in the notification documents to be sent out to the group members. The order options user interface 360 also includes a date box 362 in which the group order organizer can specify, if desired, a due date by which time all orders must be in before the order is closed. The user interface 360 may also provide a reminder tool 363 which allows the group order organizer to specify if, and when, a reminder of the order is to be sent out. The order options user interface 360 also includes payment-specific options 364, such as individual controls for setting whether the group order organizer will make the payment or whether the individual members are to make their respective payments on their own behalf. The user interface 360 also includes options related to shipping 365, including controls to select whether the respective individual members' items are to be shipped to the group order organizer 365a or directly to the individual group members 365b. In an embodiment, the options set on this screen apply globally to all group members. If it is desired to set different options differently for any of the group members, the group order organizer can click on the Advanced Options button 366 to display the Advanced Options user interface 350 previously discussed in connection with FIG. 3E.

When the group order organizer has completed configuring the item features and order options via the user interfaces shown in FIGS. 3A-3F, the group order organizer can click the Submit button 367 (FIG. 3F). The Submit button 367 is an active control which initiates the generation and sending of the group member-specific group order notification documents to the group members who are designated as intended to be notified.

Upon selection of the Submit button 367, the group order tool generates a set of member-specific group order notification documents, each corresponding to a different member in the group. FIG. 4A shows an example group order notification document in the form of an email message 400 which includes a greeting 401 which populates a name field with the group member's name, the message 402 that the group order organizer entered in the message text box, instructions 403 on how the individual group member is invited to respond, one hyperlink 404a, 404b . . . , 404n for each allowed selection combination (i.e., Ladies' style t-shirt in size Small, Men's style t-shirt in size small, Ladies' style t-shirt in size Medium, etc.). The group order notification document 400 also includes notification 405 of the due date for the order.

In operation, the group order notification document 400 is sent to the email address of the individual group member, John Doe. John Doe can open the email message via an email application to view the group order notification document 400. When John Doe clicks on one of the hyperlinks associated with a desired feature combination, for example, the hyperlink 404b associated with the selection combination of Men's style t-shirt in size small, the desired selection combination is received and processed at the server 210 by the group order tool 216. The hyperlink 404b includes the URL of the server 210 and further includes the path for invoking group order selection processing code on the server 210. Each hyperlink 404a, 404b, 404h is encoded with an identifier associated with the group member, along with the member's chosen selections for the order (e.g., in this example, the t-shirt style and t-shirt size). The group order selection processing code executing on the server 210 parses the encoded information contained in the hyperlink, associates the parsed selections with the group member per the identifier parsed from the hyperlink, and updates the individual group member's selections related to the group order.

As noted previously, in an embodiment each individual group member associated with a group order who is designated to receive notification of the group order receives a different notification document and the notification document is unique to each member. The group order tool 216 generates for each individual group member a group order notification document that includes active controls that contain a unique identifier associated with the individual group member so that when the individual group member responds to the group order notification document by making selections as instructed, the response will have embedded therein the unique identifier. In this way, the group order tool 216 is able to match up responses to the corresponding group order and individual group member.

Since each group order notification document is unique to each individual group member, other aspects of the group order notification document can be further customized. For example, if the name of the group member is known, either by matching the input contact information associated with the group member to a name field in a contacts database, or by manual entering of the group member's name by the group order organizer during the group order configuration process, the greeting 401 can be customized to address the group member by their name (e.g., in this example, Dear John). As further example, the content of the group order notification document may be customized to include only those instructions and solicited input controls that apply to the group member as configured in the group order. For example, if in the group member configuration the participant is designated as not needing to make a payment, the hyperlinks 404a-404h in the group order notification document may be encoded to indicate to the group order tool that the payment step should be skipped. Thus, the group order notification document received by one group member associated with a group order may appear different than the group order notification document received by a different member of the group, and may further include different selection options as determined by the group order configuration set up by the group order organizer.

The complexity of the group order notification document may depend on how much information and feature selection is solicited from the individual group members. For example, a simple email message containing selection hyperlink controls such as shown in FIG. 4A may work well when the number of selections from which the group member is allowed to select is low. As selection features are added, the number of hyperlink controls that are needed in this type of format increases, in which case, it may make more sense to provide a different type of interface. In an embodiment shown in FIG. 4B, the email message 410 may contain a hyperlink 411 which when clicked displays a group order notification document unique to the member as a page on a website, for example 420 shown in FIG. 4C. In this embodiment, the individual group member can display the notification document in a web browser, make selections, make a payment (if required), and submit their order.

In an embodiment, the group order notification document 420 can also be automatically displayed when the user opens the email message.

It will be appreciated that a group order notification document can also be sent to an individual group member via the member's SMS number, and corresponding response functionality can be built into the group order notification document for submission via an SMS channel.

It will further be appreciated that the group order tool 216 can be configured to intelligently select the simplest format for the group order notification document based on the complexity of the configuration of the group order. For example, the group order tool 216 may be configured to send an email (for example, as shown in FIG. 4A) containing the group order notification document itself (which contains selection controls) when the number of selections solicited from the group member is below a threshold number (e.g., 8 possible selection combinations), and otherwise configured to send a simplified email (for example, as shown in FIG. 4B) containing a link to web page (for example, as shown in FIG. 4C) where a more advanced user interface is presented to the group member to extract group member selections. Other format selection configurations can be implemented using coded logic implementing the group order tool 216.

When the group order configuration is set up to have individual group members make a payment or to have the ordered item(s) shipped directly to the group member's themselves, the group order tool 216 will recognize this configuration from the group order configuration set up by the group order organizer, and upon selection of the item features and other solicited information, will automatically direct the group member to a payment and/or shipment page. Online payment and shipment checkout processes are well known in the art, and are typically performed by a 3^{rd} party payment processing service and/or 3^{rd} party fulfillment service. The payment and shipment information process can be included as a step in the flow of the group order processing.

As shown, various payment and shipping options may be offered to accommodate various different use cases of the group order tool. A sports team, for example, may want one point person to manage the payment and have the team shirts to come to the team manager for managing the distribution of the shirts. A college reunion coordinator may want each friend in the group to pay for their own shirt and have the shirt shipped directly to them. The user interface includes controls to specify the desired method of payment and shipping.

Once the group order details are complete, the group order organizer can click on a control to initiate the generation of the group order user interface and to send the notification of the group order and group order user interface to each of the individual group members specified in notification list.

FIG. 5 is a flowchart illustrating the operation of an exemplary embodiment of the group order system. As illustrated, the group order tool provides a user interface for configuring group order details and group order members (step 501). Member specific group order notification documents containing controls for allowing individual group members to input solicited information are generated by the group order tool (step 502). The group order tool notifies members of the group order and includes some form of access to member-specific group order notification documents (step 503).

The group order tool then receives solicited member-specific input via the controls in the member-specific group order notification documents and updates the group order with the member's solicited information (step 504). When all solicited information is received, and/or when the order due date is reached (step 505), the group order tool notifies the group order organizer (step 506). The group order organizer can review the final order, make any changes if desired, make payment if desired, and submit the final order to be processed and fulfilled (step 507). Alternatively, the group order organizer can set the finalization to be performed automatically.

FIG. 6 is a block diagram showing the functional components of an exemplary embodiment of a group order tool 300. The functional components are implemented in software which executes on one or more server machines. The functional components may be distributed across multiple additional functional components (not shown) which may further be distributed across multiple different servers and/or computerized machines. As illustrated, the group order tool 300 includes a group order creation and configuration engine 610 which handles the user interface for creating, initializing, collecting and storing the item configuration, the order options, the group member information, etc. that are included in the details of the group order. The group order tool 300 also includes a group order notification document generate engine 620 which is configured to generate group order notification documents, including member specific documents which contain controls and other information specific to the individual group member.

The group order tool 300 also includes a group order notification engine 630 which notifies individual group members of the group order and provides a group order notification document for soliciting member-specific order information.

The group order tool 300 further includes a group order management engine 640 which provides a user interface (see FIG. 3G) allowing the group order organizer to review the configurations and status of the order and status of response collection, and further to make changes and/or finalize the order. The group order tool 300 includes a group order finalization engine 650 which handles the final group order submission of the final group order 204 to a fulfillment server 230 (see FIG. 2).

In sum, the group order tool, system and method provide a simplified efficient technique for creating a group order and soliciting and managing information from multiple members of a group. It further provides unprecedented flexibility in allowing a group order organizer to configure any feature of any item, and any option associated with the order itself on a feature/option by feature/option basis. Further, it allows features/options to be customized on a member by member basis. Instead of setting up an order and requiring everyone to log in to a system to make preference selections, the group order tool pushes the notification and individual member-specific notification documents containing member-specific response controls to the individual group members, thereby simplifying and providing more efficiency and convenience to the group order process.

FIG. 7 illustrates a computer system 710 that may be used to implement any of the servers, computer systems, and/or mobile devices discussed herein. Components of computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures.

Computer 710 typically includes a variety of computer readable media. Computer readable media can be any available media that can be accessed by computer 710 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 710. Computer storage media typically embodies computer readable instructions, data structures, program modules or other data.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736, and program data 737.

The computer 710 may also include other removable/non-removable, volatile/nonvolatile computer storage media. By way of example only, FIG. 7 illustrates a hard disk drive 740 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media discussed above and illustrated in FIG. 7 provide storage of computer readable instructions, data structures, program modules and other data for the computer 710. In FIG. 7, for example, hard disk drive 741 is illustrated as storing operating system 744, application programs 745, other program modules 746, and program data 747. Note that these components can either be the same as or different from operating system 734, application programs 735, other program modules 736, and program data 737. Operating system 744, application programs 745, other program modules 746, and program data 747 are given different numbers here to illustrate that, at a minimum, they are different copies. A user may enter commands and information into the computer 710 through input devices such as a keyboard 762 and pointing device 761, commonly referred to as a mouse, trackball or touch pad. Other input devices (not shown) may include a microphone, joystick, game pad, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. In addition to the monitor, computers may also include other peripheral output devices such as speakers 797 and printer 796, which may be connected through an output peripheral interface 790.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include a local area network (LAN) 771 and a wide area network (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760, or other appropriate mechanism. In a networked environment, program modules depicted relative to the computer 710, or portions thereof, may be stored in the remote memory storage device. By way of example, and not limitation, FIG. 7 illustrates remote application programs 785 as residing on memory device 781. It will be appreciated that the network connections shown are exemplary and other means of establishing a communications link between the computers may be used.

The system and techniques just described have several advantages. First, multiple articles of manufacture may be engraved in a single engraving job, resulting in savings of time and operator attention for loading and unloading articles of manufacture into the engraving station for engraving. Second, the articles can be engraved through transparent packaging so that the articles need not be removed from their packaging prior to engraving, saving time, cost, and materials.

Those of skill in the art will appreciate that the invented method and apparatus described and illustrated herein may be implemented in software, firmware or hardware, or any suitable combination thereof. Thus, those of skill in the art will appreciate that the methods and systems described herein may be implemented by one or more processors executing computer-readable instructions being stored for execution on one or more computer-readable media. Alternative embodiments are contemplated, however, and are within the spirit and scope of the invention.

Although this preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A method for facilitating group orders, comprising:
providing a user interface which allows a user to select one or more items to be included in a group order, to configure one or more features of the group order, to configure one or more of the features of the group order to be configurable by individual group members, to provide contact information associated with one or more group members to be included in the group order, and to generate a group order notification document associated with the group order, the group order notification document containing one or more controls to allow a group member recipient of the group order notification document to indicate a desired configuration for the group member configurable features specific to the group member recipient;
receiving from selections of one or more items to be included in a group order, receiving configurations of one or more features of the group order, receiving configurations of one or more features of the group order to be configurable by individual group members, and receiving contact information associated with one or more group members to be included in the group order;
generating at least one group order notification document associated with the group order, each group order notification document containing one or more controls to allow a group member to indicate a desired group member configurable features configuration specific to that group member;
associating at least one of the at least one group order notification documents with each group member from which configurable feature selections are solicited;
notifying each group member from which configurable feature selections are solicited of the group order and providing access to the group order notification document associated with the notified group member;
receiving, via the one or more controls in at least one of the at least one group order notification documents, one or more desired configurations specific to a notified group member; and
updating the group order configurations with the received configurations specific to the notified group member.

2. The method of claim 1, wherein at least one of the at least one group order notification documents is a browser-renderable page.

3. The method of claim 1, wherein at least one of the at least one group order notification documents is an email message.

4. The method of claim 1, wherein at least one of the at least one group order notification documents is a text message.

5. A group ordering system, comprising:
a user interface which allows a user to select one or more items to be included in a group order, to configure one or more features of the group order, to configure one or more of the features of the group order to be configurable by individual group members, to provide contact information associated with one or more group members to be included in the group order, and to generate a group order notification document associated with so the group order, the group order notification document containing one or more controls to allow a group member recipient of the group order notification document to indicate a desired configuration for the group member configurable features specific to the group member recipient;
one or more processors configured to receive selections of one or more items to be included in a group order, receive configurations of one or more features of the group order, receive configurations of one or more features of the group order to be configurable by individual group members, and receive contact information associated with one or more group members to be included in the group order;
one or more processors configured to generate at least one group order notification document associated with the group order, each group order notification document containing one or more controls to allow a group member to indicate a desired group member configurable features configuration specific to that group member;
one or more processors configured to associate at least one of the at least one group order notification documents with each group member from which configurable feature selections are solicited;
one or more processors configured to notify each group member from which configurable feature selections are solicited of the group order and providing access to the group order notification document associated with the notified group member;
one or more processors configured to receive, via the one or more controls in at least one of the at least one group order notification documents, one or more desired configurations specific to a notified group member; and
one or more processors configured to update the group order configurations with the received configurations specific to the notified group member.

6. The system of claim 5, wherein at least one of the at least one group order notification documents is a browser-renderable page.

7. The system of claim 5, wherein at least one of the at least one group order notification documents is an email message.

8. The system of claim 5, wherein at least one of the at least one group order notification documents is a text message.
